(19) United States
(12) Patent Application Publication
(10) Pub. No.: US 2006/0204182 A1
(43) Pub. Date: Sep. 14, 2006

(54) APPARATUS AND METHOD FOR COUPLING A FIBER TO A PHOTODETECTOR

(75) Inventor: STEFAN J. MURRY, Houston, TX (US)

Correspondence Address: APPLIED OPTOELECTRONICS, INC., 13111 JESS PIRTLE BLVD., SUGAR LAND, TX, 77478, US

(73) Assignee: APPLIED OPTOELECTRONICS, INC., SUGAR LAND, TX (US)

(21) Appl. No.: 10/906,964

(22) Filed: Mar. 14, 2005

(51) Int. Cl. G02B 6/36

(52) U.S. Cl. 385/88; 385/92

(57) ABSTRACT

A fiber-photodetector coupling apparatus and method for coupling a fiber to a photodetector. A photodetector is mounted on one surface of the platform, with its active region facing an opening in the platform. A fiber inserted into the opening from the opposite surface of the platform is secured in said opening so that its output optical signal is directed onto the active region of the photodetector.

### BACKGROUND OF THE INVENTION

1. Field of the Invention

This invention relates to laser packaging and, in particular, to apparatuses and methods for optically coupling an optical fiber to a photodetector.

2. Description of the Related Art

The following descriptions and examples are not admitted to be prior art by virtue of their inclusion within this section.

Semiconductor lasers are used in a variety of applications, such as high-bit-rate optical fiber communications. In telecommunications applications, the laser often emits at a single lasing wavelength at 1.31 μm (and other closely spaced wavelengths), or at telecommunications wavelengths specified by the ITU grid, such as lasing wavelengths of 1.55 μm (and other closely spaced wavelengths). These wavelength ranges are often used for telecommunications purposes because the loss of silica fibers is comparatively low at these wavelengths.

In optical fiber communications systems, the semiconductor laser that generates the modulated digital or analog optical signal is optically coupled into one end (input or light-receiving end) of an optical fiber.

At the other end of the fiber (output or light-transmitting end), the optical signals are directed into a receiver. The receiver typically employs a photodetector to generate an electrical signal in response to the optical signal impinging thereon. The term photodetector is sometimes used, and is used herein, to refer to any type of radiation detector, i.e. a detector that detects electromagnetic radiation. One type of photodetector is the two-layer junction photodetector, or photodiode, which has a semiconductor p-n junction that produces electrical current under illumination with electromagnetic radiation. In some applications, simple, albeit low-performance, single-layer photoconducting type photodetectors are employed.

Various modules, assemblies or packages are used to hold the laser, other optical components (such as collimation and coupling lenses, isolators, and the like), and optical fiber while being aligned with each other so as to permit the laser to be optically coupled to the fiber, i.e. light output from the laser is transmitted into the fiber. The process of aligning an optical fiber to a laser diode and fixing it in place is sometimes known as fiber pigtailing. It is also common to provide a photodetector in the same package as the laser, to function as a check device to verify the proper operation of the laser. This photodetector is sometimes referred to as a “monitor photodetector” or “monitor photodiode,” due to its function in monitoring the output power of the laser.

Likewise, the photodetector in the receiver module must be mounted with the fiber so that the light output from the output end of the fiber is directed onto the active, or light-receiving, region of the surface of the photodetector. A TO (transistor outline) can type package or housing is typically used to align and position the photodetector, fiber, and related optical components to each other so the fiber is optically coupled to the photodetector (i.e., so that the photodetector receives the light from the output end of the fiber such that it can generate a useful electrical signal corresponding to the optical signal). Typically, the photodetector is mounted in the TO can housing and the fiber is actively aligned with respect to the photodetector, and then fixed into the aligned position.

In a TO can housing-mounted photodetector, because the laser-generated light that constitutes the optical signal begins to diverge upon exit from the output end of the fiber, and because of the distance between the fiber and the photodetector due to the physical dimensions of conventional TO can housing, a lens is also typically mounted within the TO can housing to focus the output optical signal onto the active region of the photodetector.

### BRIEF SUMMARY OF THE INVENTION

A fiber-photodetector coupling apparatus and method for coupling a fiber to a photodetector. A photodetector is mounted on one surface of the platform, with its active region facing an opening in the platform. A fiber inserted into the opening from the opposite surface of the platform is secured in said opening so that its output optical signal is directed onto the active region of the photodetector.

### BRIEF DESCRIPTION OF THE SEVERAL VIEWS OF THE DRAWING

Other features and advantages of the invention will become apparent upon study of the following description, taken in conjunction with the attached FIGS. 1-4.

FIG. 1 is a cross-sectional view of an apparatus for coupling a fiber to a photodetector, in accordance with an embodiment of the invention;

FIG. 2 is a rear perspective view of the apparatus of FIG. 1, in accordance with an embodiment of the present invention;

FIG. 3 is a cross-sectional view of an apparatus for coupling a fiber to a photodetector mounted at an angle, in accordance with an alternative embodiment of the invention; and

FIG. 4 is a cross-sectional view of an apparatus for coupling a fiber to a photodetector employing the photodetector-mounting epoxy as a fiber stop, in accordance with an alternative embodiment of the invention.

### DETAILED DESCRIPTION OF THE INVENTION

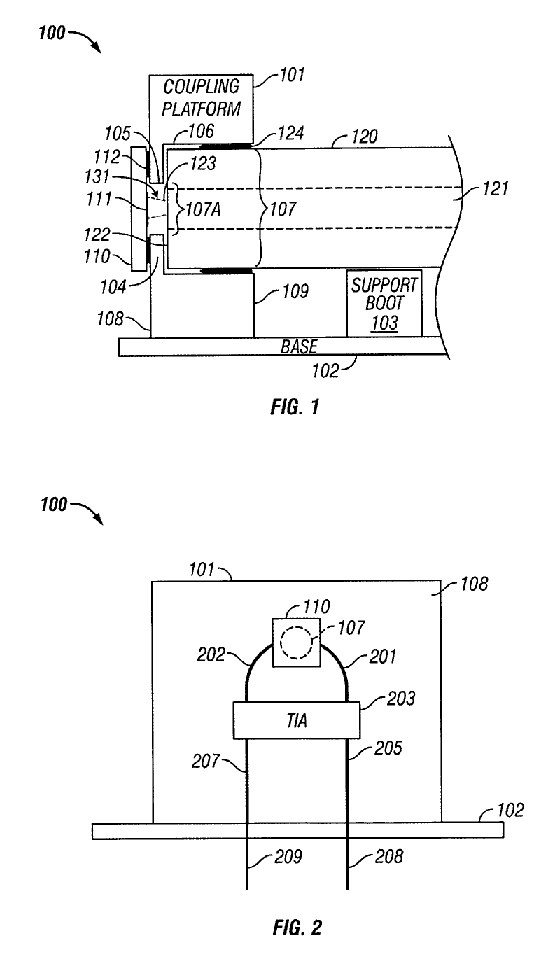

The present invention provides a fiber-photodetector coupling apparatus and method for coupling a fiber to a photodetector. In an embodiment, the apparatus is for lens-free coupling of the fiber to a photodetector. Referring now to FIG. 1, there is shown a cross-sectional view of an apparatus 100 for lens-free coupling a fiber 120 to a photodetector 110, in accordance with an embodiment of the invention. Apparatus 100 comprises a coupling platform or block 101, which is preferably composed of a rigid material such as silicon or ceramic. Platform 101 preferably has substantially planar, opposing parallel surfaces 108, 109, which may be referred to herein as the front side or surface 109, and the back side or surface 108.

An opening (aperture or through-hole) 107 extends through platform 101 from the first surface 109 to the second surface 108. Opening 107 is preferably substantially cylindrical and has an inner diameter 106 for most of its length that is slightly greater than the outer diameter of fiber 120. A portion of opening 107 on the back side 108 is a smaller opening 107a which comprises a ledge or stop 104 with an inner diameter 105 that is smaller than the outer diameter of fiber 120.

Photodetector chip 110 is mounted on the back side 108 of coupling platform 101 with its epitaxially grown active region 111 facing and substantially centered on the smaller opening 107a. It is secured onto back surface 108 by epoxy 112 or other means such as laser welding or soldering. Fiber 120 is inserted into the main part of opening 107 from the front side 109 of coupling platform 101, until it abuts against stop 104. It may be affixed to coupling platform 101 via epoxy 124 or other fastening means. As can be seen, laser core 121 is automatically and passively aligned with the active region 111 of photodetector 110. Because the axial-direction thickness of stops 104 may be selected to be very small, the output end 122 of fiber 120 is very close to active region 111, so that the output light or optical signal 123 is directly coupled onto active region 111 without employing a lens or the expense thereof. In alternative embodiments, instead of completely passive alignment, after the fiber is secured in the opening, the photodetector may be actively positioned to achieve some desired optical coupling.

In an embodiment, as illustrated in FIG. 1, coupling platform 101 may be mounted on its bottom side onto a base 102. A support boot 103 may also be mounted on base 102 some distance away from the front side 109 of coupling platform 101, to provide extra support for the length of fiber 120 extending out of opening 107.

Note that platform 101 and/or base 102 may be, and preferably are, composed of silicon, which can be more easily integrated with CMOS technology circuit boards than a metal housing can be, such as a metal TO can housing.

In an alternative embodiment, the volume 131 of opening 107 between the end 122 of fiber 120 and the active region 111 surface of photodetector 110 may be filled with some material such as a liquid or semi-liquid. The liquid filling the volume 131 may be employed for index-matching purposes, for example. For example, the index of fiber (glass) is usually about 3, and that of a typical photodetector active region may be approximately 1.5. A material having an index between these two indexes—ideally about half-way between—may be employed to reduce back-reflection that is typically greater for larger index changes.

Opening 107 and its smaller portion 107a may be formed by any suitable technique, such as drilling, laser, etching, or nanotechnology. In alternative embodiments, instead of a cylindrical opening 107, an opening may have a tapered profile and somewhat conical shape, where the opening portion at the front surface 109 is larger and the diameter tapers down to a smaller diameter at the back surface 108, where the smaller diameter is smaller than the outer diameter of the fiber to serve as a stop.

Referring now to FIG. 2, there is shown a rear perspective view of apparatus 100 of FIG. 1, in accordance with an embodiment of the present invention. In both photodiodes and photoconductor type photodetectors, the conductivity of photodetector is related in a known way to the incident light intensity. Thus, when properly biased, photodetector 110 produces an electrical signal corresponding to the intensity of light impinging on the active region 111. Proper biasing may be provided by, and electrical signal output read from, photodetector electrical contacts 201, 202. Suitably designed electronics, functionally coupled to terminals 201, 202, can therefore measure the appropriate electrical parameter (e.g., electrical conductivity) of the layer to determine the incident light intensity. For example, in embodiments in which photodetector 110 is a photoconductor, terminals 201, 202 on opposing sides provide a biasing voltage across the resistance of the photoconductor layer 111; as light is absorbed, more carriers are created, thus lowering the resistance and increasing the current.

Terminals 201, 202 may be backside contacts or wraparound contacts, and consist, in an embodiment, of metallization deposited on the back surface 108 of the coupling platform 110. This metallization may be extended to pin contacts 208, 209 in base 102, so that when coupling platform 110 and base 102 are mounted onto a circuit board, the pins are easily connected to the appropriate contacts on the circuit board. The biasing circuitry may be provided externally, and connected to pins 208, 209, or may be provided in a circuit mounted onto and/or incorporated in or with coupling platform 110. This circuitry and/or other circuitry or devices or components may be mounted directly on coupling platform 110. For example, as illustrated in FIG. 2, a device such as a transimpedance amplifier (TIA) 203 may be mounted on the back surface 108 of coupling platform 110 along with photodetector 110, and may be inserted electrically between photodetector metallization contacts 201, 202 and pins 208, 209 via metallization contacts 205, 207.

In an alternative embodiment, coupling platform 101 is itself a TIA with opening 107 and photodetector 110 mounted over said opening on the back side of said TIA. One advantage of the present invention is that because the photodetector is mounted on the non-conductive platform, it can be directly coupled to electrical contacts which can be designed to minimize impedance mismatching. For example, a transmission line having a desirable impedance could be brought arbitrarily close to the photodiode, minimizing the length of any impedance mismatched element, which would reduce electrical reflection and increase the efficiency of the transmission of electrical energy from the photodiode into the external circuitry.

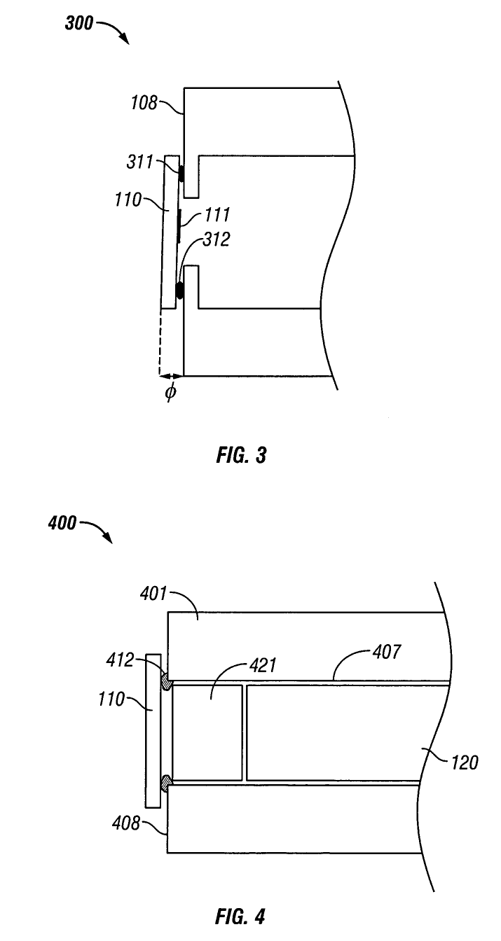

Mounting a photodetector with its active region surface orthogonal to the axis of the fiber can result in back reflection into the fiber, which is undesirable. Referring now to FIG. 3, there is shown a cross-sectional view of an apparatus 300 for coupling a fiber to a photodetector 110 mounted at an angle, in accordance with an alternative embodiment of the invention. In apparatus 300, which is similar in many respects to apparatus 100 of FIG. 1, photodetector 110 is mounted at an angle Φ with respect to the plane of the back surface 108 of coupling platform 101. This may be done by using blobs of epoxy having different thicknesses, e.g., epoxy 312 is thicker than epoxy 311. Such an embodiment may reduce back reflection into the fiber (now shown in FIG. 3). In alternative embodiments, materials other than epoxy, such as solder, may be employed; and photodetector 110 may be mounted at an angle using other suitable techniques. Alternatively, instead of or in addition to mounting photodetector 110 at an angle with respect to the plane of the back surface 108 of coupling platform 101, the axis of opening 107 is at an angle with respect to the plane of the back surface 108 of coupling platform 101, instead of being orthogonal thereto.

Referring now to FIG. 4, there is shown a cross-sectional view of an apparatus 400 for coupling a fiber 120 to a photodetector 110 employing photodetector-mounting epoxy or other bonding material 412 as a fiber stop, in accordance with an alternative embodiment of the invention. In this embodiment, opening 407 is substantially cylindrical, but does not employ a smaller-diameter stop portion as in apparatus 100. In the embodiment illustrated in FIG. 4, when photodetector 110 is mounted on back surface 408 of coupling platform 401, the epoxy or other bonding material (e.g., solder) is intentionally applied so that some of it extends into the opening 407 sufficient to serve as a stop for fiber 120, or for other components between fiber 120 and photodetector 110, such as element 421. In alternative embodiments, a coupling platform such as platform 401 may be employed, but photodetector 110 is mounted without epoxy intruding into opening 407. In this case, the photodetector's active region surface could serve as the stop for fiber 120, or the fiber could be precisely aligned within the opening without the use of a stop.

In an embodiment, such as illustrated in FIG. 4 but as may be employed also in other embodiments such as that depicted in FIG. 1, one or more optical elements may be placed in-line with the fiber in this manner, such as a filter or optical isolator. For example, a filter may be employed in cases where the photodetector is to detect only a given wavelength. By employing the coupling platform approach of the present invention, these elements would be automatically and passively aligned between the fiber output end and the photodetector. In an alternative embodiment, a lens may be placed in-line with the fiber, if so desired.

The present invention, therefore, is well adapted to carry out the objects and attain the ends and advantages mentioned, as well as others inherent therein. While the invention has been depicted and described and is defined by reference to particular preferred embodiments of the invention, such references do not imply a limitation on the invention, and no such limitation is to be inferred. The invention is capable of considerable modification, alteration and equivalents in form and function, as will occur to those ordinarily skilled in the pertinent arts. The depicted and described preferred embodiments of the invention are exemplary only and are not exhaustive of the scope of the invention. Consequently, the invention is intended to be limited only by the spirit and scope of the appended claims (if any), giving full cognizance to equivalents in all respects.

1. An assembly for mounting an optical fiber with respect to a photodetector having an active region, the assembly comprising:
(a) a rigid coupling platform having a first surface, a second surface opposite the first surface, and an opening between said surfaces, said opening having at least a first portion open to said first surface for receiving an optical fiber having an outer diameter;
(b) said photodetector mounted on said first surface with its active region facing and disposed over said opening; and
(c) said fiber inserted at an end of the fiber into said first portion of said opening from said second surface and secured to said coupling platform, whereby light emitted from said end of said fiber is directed onto said active region.

2. The assembly of claim 1, wherein the coupling platform is composed of one of ceramic and silicon.

3. The assembly of claim 1, wherein the first and second surfaces of the coupling platform are substantially planar and parallel to each other.

4. The assembly of claim 1, wherein the first portion of the opening in the coupling platform is substantially cylindrical and has an inner diameter slightly larger than the outer diameter of the fiber.

5. The assembly of claim 4, wherein the opening in the coupling platform comprises a second portion open to the second surface, said second portion being smaller than the outer diameter of the fiber so that said second portion forms a stop for said end of said fiber when said fiber is inserted into the first portion of the opening in the coupling platform, wherein said photodetector is mounted on said first surface of the coupling platform with its active region facing said second portion of said opening.

6. The assembly of claim 5, wherein the second portion of the opening in the coupling platform is substantially cylindrical and has an inner diameter smaller than the outer diameter of the fiber and said photodetector is mounted on said first surface of the coupling platform with its active region facing and substantially centered on said second portion of said opening.

7. The assembly of claim 1, wherein the opening in the coupling platform is substantically conical and has a profile that tapers from a larger inner diameter at the first surface down to a smaller inner diameter at the second surface, wherein the inner diameter of the opening at the first surface is larger than the outer diameter of the fiber and the inner diameter of the opening at the second surface is smaller than the outer diameter of the fiber.

8. The assembly of claim 1, wherein said assembly comprises no lens between said end of said fiber and said active region of said photodetector, whereby said fiber is directly optically coupled with said photodetector.

9. The assembly of claim 1, further comprising a base, wherein said coupling platform is mounted to a surface of the base so that its first and second surfaces are substantially orthogonal to said surface of the base and the fiber is substantially parallel to the base, further comprising a support boot mounted to the base and beneath said fiber extending out of the first portion the opening to support said fiber.

10. The assembly of claim 9, wherein said coupling platform and base consist of silicon.

11. The assembly of claim 1, wherein the volume of the opening between the active region and the end of the fiber is filled with a material.

12. The assembly of claim 11, wherein the material is one of a liquid or semi-liquid and has an index of refraction between the indices of refraction of the active region and the fiber.

13. The assembly of claim 1, further comprising a pair of electrical contacts electrically coupled to the photodetector and disposed on said first surface of the coupling platform, wherein the coupling platform is composed of one of ceramic and silicon.

14. The assembly of claim 13, further comprising a transimpedance amplifier (TIA) mounted on the first surface of the coupling platform, wherein the electrical contacts are electrically coupled to the TIA and to the photodetector.

15. The assembly of claim 1, wherein the photodetector is mounted at an angle with respect to the first surface of the coupling platform so as to reduce back-reflection.

16. The assembly of claim 15, wherein the photodetector is mounted to the coupling platform employing epoxy blobs of different size so as to cause the photodetector active region to be at an angle with respect to the first surface of the coupling platform.

17. The assembly of claim 1, wherein the opening has an axis that is at a non-orthogonal angle with respect to the first surface of the coupling platform so as to reduce back-reflection.

18. The assembly of claim 1, wherein:
the opening is substantially cylindrical;
the photodetector is mounted to the coupling platform employing bonding on said first surface around said opening, some of which extends into the opening to form a stop for said end of said fiber when said fiber is inserted into the first portion of the opening in the coupling platform.

19. The assembly of claim 1, further comprising an optical element placed in-line in said opening, between the end of the fiber and the active region, wherein said optical element comprises one of an optical filter and an optical isolator.

20. An assembly for mounting an optical fiber with respect to a photodetector having an active region, the assembly comprising:
(a) a coupling platform means having a first surface and a second surface and comprising an opening means for receiving an end of the optical fiber from said second surface and for positioning said end of said fiber toward the first surface of the coupling platform means;
(b) said photodetector mounted on said first surface of the coupling platform means with its active region facing and proximate to said end of said fiber; and
(c) said fiber mounted in and secured to said opening means, whereby light emitted from said end of said fiber is directed onto said active region.
